(19) United States
(12) Patent Application Publication
(10) Pub. No.: US 2008/0099971 A1
(43) Pub. Date: May 1, 2008

(54) QUICK CONNECT FASTENER ASSEMBLY

(75) Inventor: Michael J. Brown, Baltimore, MD (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: ADCOR INDUSTRIES, INC., Baltimore, MD (US)

(21) Appl. No.: 11/931,532

(22) Filed: Oct. 31, 2007

Related U.S. Application Data
(60) Provisional application No. 60/863,689, filed on Oct. 31, 2006.

(51) Int. Cl. B23Q 3/00

(52) U.S. Cl. 269/289 R; 403/345

(57) ABSTRACT

A work support apparatus includes a pedestal, a mounting block, and a plurality of fasteners disposed on the pedestal to interconnect the mounting block to the pedestal. The fasteners are mounted to the pedestal and include a locking mechanism extending outwardly from the pedestal. The mounting block defines a plurality of bores extending through the mounting block for receiving the locking mechanism of the fasteners therein. The mounting block may be oriented in several different orientations by positioning the mounting block on different groups of fasteners. The locking mechanism of the fasteners includes a wedge pin which extends through the bore of the mounting block for selective engagement by an actuator to release the mounting block from the fastener.

### CROSS REFERENCE TO RELATED APPLICATION

This application claims the benefit of Provisional Patent Application Ser. No. 60/863,689 filed Oct. 31, 2006, the disclosure of which is hereby incorporated by reference.

### BACKGROUND OF THE INVENTION

1. Field of the Invention

The subject invention relates to a work support apparatus for positioning a work piece, and more specifically to a fastening assembly for interconnecting a mounting block of the work support apparatus to a pedestal of the work support apparatus.

2. Description of the Prior Art

Fastener assemblies are often used for interconnecting a variety of devices. The devices may include such things as a robotic arm, a work support, a work stand, a work holder, a tool or some other similar devices. Often, the devices include multiple fastener assemblies for connecting the devices in any of several different positions to ease machining and work procedures.

U.S. Pat. No. 4,016,914 to Zurko discloses a self-locking panel fastener assembly for interconnecting a first panel and a second panel. The fastener assembly includes a female portion for attachment to one of the first panel and the second panel. The female portion defines a bore and includes an annular lip within the bore. The fastener assembly further includes a male portion. The male portion includes a body having a first end and a second end. The body defines a lumen, which extends between the first end and the second end along a longitudinal axis. The body further defines a pair of openings extending through the body transverse to the longitudinal axis. The fastener further includes a pair of locking balls, with one of the locking balls disposed within each of the openings. A wedge pin is fully disposed and moveable within the lumen along the longitudinal axis. A plug is disposed within the lumen to secure the wedge pin within the lumen. The wedge pin is moveable between a lock position and a release position. The lock position biases the locking balls radially outward against the body to engage the annular lip of the female portion in interlocking engagement. The release position permits radial movement of the locking balls radially inward toward the longitudinal axis to disengage the locking balls from interlocking engagement with the annular lip of the female portion. The first end of the body defines a recess, with a portion of the wedge pin extending into the recess but not past the first end of the body. A tool is utilized to engage the portion of the wedge pin within the recess to move the wedge pin from the lock position to the release position. In other words, the tool is inserted into the recess to force the portion of the wedge pin within the recess into the lumen, thereby moving the wedge pin from the lock position to the release position. A spring is disposed within the lumen between the plug and the wedge pin to bias the wedge pin into the lock position.

### SUMMARY OF THE INVENTION AND ADVANTAGES

The subject invention provides a work support apparatus for positioning a work piece. The work support apparatus comprises a pedestal, a mounting block defining at least one bore extending through the mounting block and a plurality of fasteners mounted to the pedestal. The work piece is attachable to the mounting block. The plurality of include a first group of fasteners for attaching the mounting block to the pedestal in a first orientation, and a second group of fasteners for attaching the mounting block to the pedestal in a second orientation. The workpiece is orientated relative to the pedestal without detachment from the mounting block by attaching the mounting block to one of the first group of fasteners and the second group of fasteners. Each of the plurality of fasteners include a locking mechanism, which extends outwardly from the pedestal for engaging the mounting block in interlocking engagement and is actuated through the bore of the mounting block.

The subject invention also provides a fastening assembly for interconnecting the mounting block and the pedestal, and operable by the actuator. The fastener assembly comprises a female portion and a male portion. The Female portion is for attachment to one of the mounting block and the pedestal, and defines a bore and an annular groove within the bore. The male portion is for attachment to another of the mounting block and the pedestal, and includes a body having a first end and a second end. The body defines a lumen extending between the first end and the second end along a longitudinal axis, and further defining a plurality of openings extending through the body transverse to the longitudinal axis. The male portion of the fastener assembly further includes a plurality of locking balls, with one of the plurality of locking balls disposed within each of the plurality of openings. A wedge pin is moveable within the lumen along the longitudinal axis between a lock position and a release position. The lock position biases the plurality of locking balls radially outward against the body to engage the annular groove of the female portion in interlocking engagement. The release position permits radial movement of the plurality of locking balls radially inward toward the longitudinal axis to disengage the plurality of locking balls from the interlocking engagement with the annular groove of the female portion. The wedge pin is partially disposed within the lumen and extends outwardly from the body through the second end of the body and through the bore of the female portion for selective engagement with the actuator to move the wedge pin from the lock position to the release position.

Accordingly, the fastener assembly of the subject invention provides a portion of the wedge pin extending through the female portion so that the actuator may engage the wedge pin from the second end of the body through the bore of the female portion, thereby providing a more convenient manner of releasing the fastener assembly. This allows the work support apparatus of the subject invention to permit several mounting blocks, each having work pieces attached thereto, to be oriented on the pedestal in a first orientation simultaneously. The work pieces are easily detached from the pedestal by accessing the locking mechanism of the fasteners through the bore of the mounting block, and easily reattached on the pedestal in a second orientation by also engaging the fasteners through the bore of the mounting block, all without having to re-orient the work piece relative to the mounting block.

### BRIEF DESCRIPTION OF THE DRAWINGS

Other advantages of the present invention will be readily appreciated, as the same becomes better understood by reference to the following detailed description when considered in connection with the accompanying drawings wherein

FIG. 1 is a perspective view of a work support apparatus showing several mounting blocks attaching work pieces to a pedestal;

FIG. 2 is a perspective view of the work support apparatus shown in FIG. 1 showing some of the mounting blocks removed;

FIG. 3 is an exploded cross sectional side view of a fastening assembly in a disconnected position;

FIG. 4 is a cross sectional side view of the fastening assembly in a connected position;

FIG. 5 is a perspective view of the fastening assembly in the connected position;

FIG. 6 is fragmentary side view of the fastening assembly in a locking position;

FIG. 7 is a fragmentary side view of the fastening assembly in a release position; and

FIG. 8 is a perspective view of the female portion of the fastening assembly.

### DETAILED DESCRIPTION OF THE INVENTION

Referring to the Figures, wherein like numerals indicate corresponding parts throughout the several views, a work support apparatus is generally shown at 20. The work support apparatus 20 positions a work piece 26 in a desired orientation such that a machining operation may be performed on the work piece 26. The work piece 26 may be machined either manually or through the use of robotics.

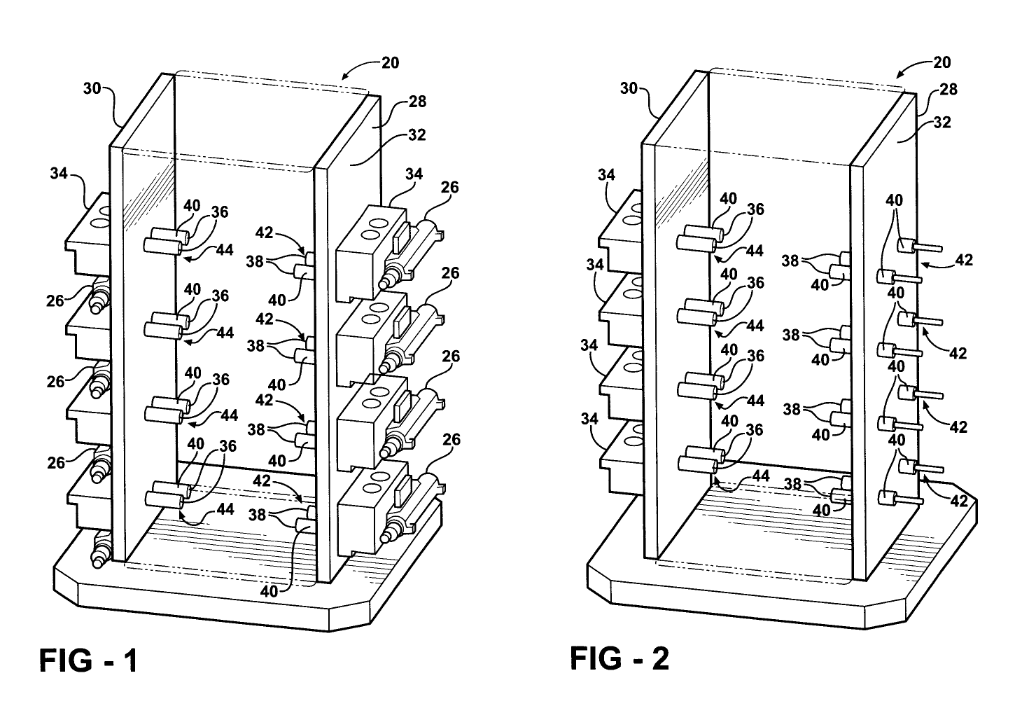

Referring to FIGS. 1 and 2, the work support apparatus 20 comprises a pedestal 28. The pedestal 28 supports the work piece 26 in a desired orientation, and may be formed in any desirable size and shape suitable to accommodate the specific size and shape of the work piece 26. Preferably, the pedestal 28 includes at least a first face 30 and a second face 32. However, it should be appreciated that the pedestal 28 may include multiple faces or only a single face.

The work support apparatus 20 further includes a mounting block 34. The work piece 26 is attachable to the mounting block 34 in any suitable manner. For example, the work piece 26 may be attached to the mounting block 34 by screws, bolts, clamps, quick connect devices, or some other suitable device capable of securely attaching the work piece 26 to the mounting block 34.

A plurality of fasteners, i.e., fastening assemblies 40, is mounted to the pedestal 28. The fasteners 40 interconnect the mounting block 34 to the pedestal 28. The structure and operation of the fasteners 40 is described in greater detail below. The fasteners 40 include a first group of fasteners 36 for attaching the mounting block 34 to the pedestal 28 in a first orientation, and a second group of fasteners 38 for attaching the mounting block 34 to the pedestal 28 in a second orientation. Preferably, and as shown in the Figures, the first group of fasteners 36 is mounted on the first face 30, and the second group of fasteners 38 is mounted on the second face 32.

The workpiece is orientated relative to the pedestal 28 without detachment from the mounting block 34 by attaching the mounting block 34 to one of the first group of fasteners 36 and the second group of fasteners 38. In other words, when the mounting block 34 is attached to the first group of fasteners 36, the work piece 26 is orientated in the first orientation. In order to perform machining operations on other areas of the work piece 26, the mounting block 34 is released from the first group of fasteners 36 and attached to the second group of fasteners 38, thereby orientating the work piece 26 in the second orientation. This is accomplished without having to detach the workpiece form the mounting block 34 and re-position the work piece 26 on the mounting block 34.

Preferably, the first group of fasteners 36 includes a plurality of first fastener subsets 42, the second group of fasteners 38 includes a plurality of second fastener subsets 44, and the mounting block 34 includes a plurality of mounting blocks 34. Accordingly, several work pieces 26 may be selectively positioned on the pedestal 28 in one of the first orientation and/or the second orientation simultaneously, thereby providing increased efficiency to the machining operations.

The fasteners 40 couple or interconnect two devices together. The devices may include any of a variety of devices such as a robotic arm, a support, a stand, a work table, a part/product, a tool, or some other similar device. As shown, the devices include the mounting block 34 and the pedestal 28. It should be appreciated that the fasteners 40 may be coupled to any number of various devices in a myriad of configurations for connecting and disconnecting the various devices as needed. As discussed in greater detail below, the fasteners 40 are releasable such that, for example, a robotic arm (not shown) may grasp and release the mounting block 34 from the pedestal 28 to re-orient the mounting block 34 and/or move the mounting block 34 to another position on the pedestal 28.

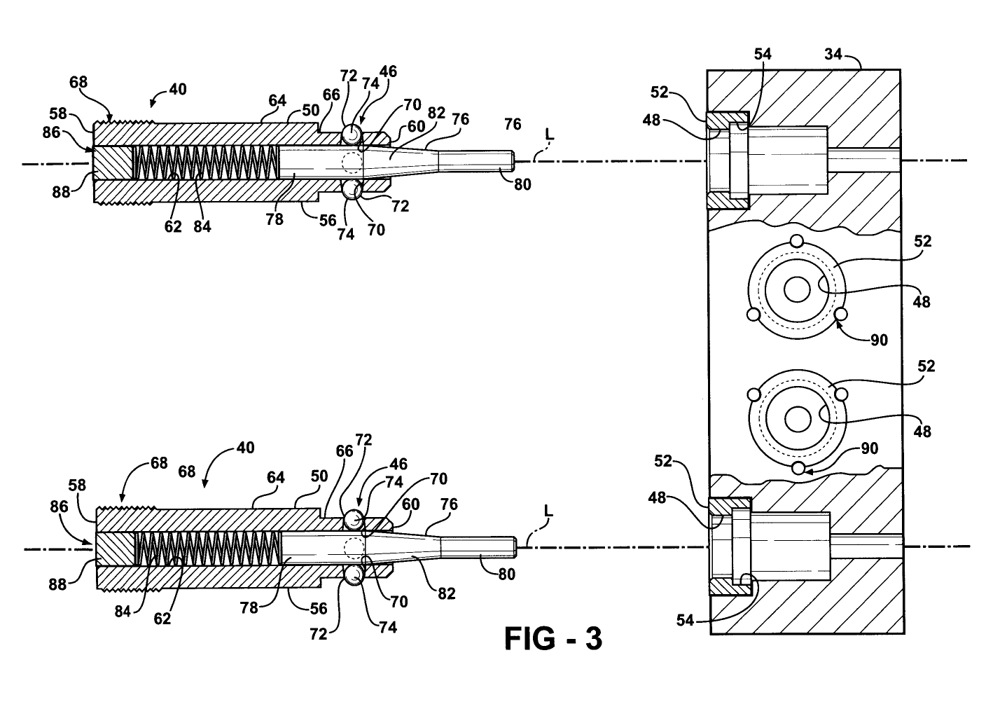

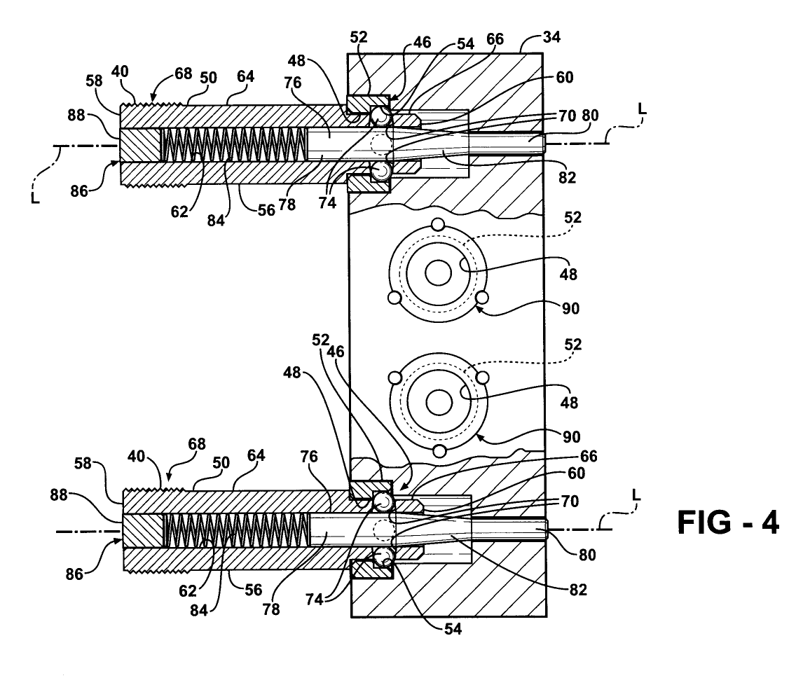

Referring also to FIGS. 3 and 4, each of the fasteners 40 includes a locking mechanism 46, which extends outwardly from the pedestal 28. The mounting block 34 defines at least one bore 48, and preferably a plurality of bores 48, with each bore 48 extending through the mounting block 34. The locking mechanism 46 engages the mounting block 34 in interlocking engagement, and is actuated through the bore 48 of the mounting block 34. Accordingly, the multiple bores 48 defined by the mounting block 34 permit the mounting block 34 to be re-positioned on the pedestal 28 in the various orientations, i.e. It should be appreciated that the first group of fasteners 36 will mate with a corresponding number of bores 48 in the mounting block 34 to position the mounting block 34 in the first orientation, and the second group of fasteners 38 will mate with a different corresponding number of bores 48 in the mounting block 34 to position the mounting block 34 in the second orientation.

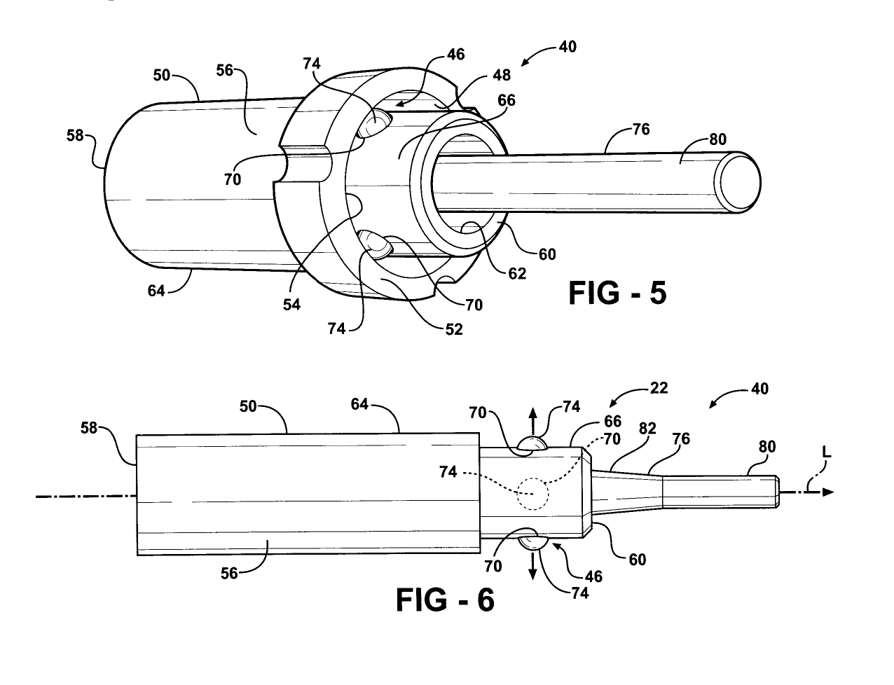

Referring to FIGS. 3 through 5, the fastening assemblies 40, i.e., the fasteners 40, include a male portion 50 and a female portion 52. The male portion 50 is for attachment to one of the mounting block 34 and the pedestal 28, and the female portion 52 is for attachment to another of the mounting block 34 and the pedestal 28. As shown in the Figures, the male portion 50 is attached to the pedestal 28 and the female portion 52 is attached to the mounting block 34. Referring to FIG. 8, the female portion 52 of the fasteners 40 defines the bore 48 extending along a longitudinal axis L and defines an annular groove 54 extending radially about the longitudinal axis L within the bore 48 of the female portion 52. It should be appreciated that the female portion 52 and the mounting block 34 may be separate pieces or may be integrally formed together. If the female portion 52 and the mounting block 34 are integrally formed, then it should be appreciated that it is the mounting block 34 that defines the bore 48 and the annular groove 54 therein.

As shown in FIGS. 1 and 2, the male portion 50 is disposed in the pedestal 28. As shown in FIGS. 3 and 4, multiple female portions 52 are disposed in the mounting block 34. Preferably, and as shown, the mounting block 34 includes a plurality of female portions 52 arranged in a pre-determined configuration and disposed on differing sides of the mounting block 34. Accordingly, the mounting block 34 may be positioned on the pedestal 28 in several different positions, i.e., a user or a robotic arm may move the mounting block 34 from one position on the pedestal 28 and reposition the mounting block 34 in a different position and orientation relative to the pedestal 28 to expose other areas of the work piece 26 to other machining operations as described above.

Referring to FIGS. 3 through 7, the male portion 50 of the fasteners 40 includes a body 56 having a first end 58 and a second end 60. The body 56 defines a lumen 62 extending between the first end 58 and the second end 60 along the longitudinal axis L, completely through the body 56. As shown, the lumen 62 has a circular cross section. However, it should be appreciated that the cross section of the lumen 62 may include some other shape.

The body 56 includes a shank portion 64 and a collar portion 66. Preferably, the shank portion 64 includes a circular cross section having a shank diameter, and the collar portion 66 includes a circular cross section having a collar diameter smaller than the shank diameter. However, it should be appreciated, that the cross section defined by the outer surface of the shank and or the collar may include some other shape, such as a rectangular shape.

The male portion 50 includes a connecting mechanism 68 for connecting the male portion 50 to one of the mounting block 34 and the pedestal 28. The connecting mechanism 68 may include threads disposed on the shank in threaded engagement with the pedestal 28 or the mounting block 34, a snap ring, a press fit into the pedestal 28 or the mounting block 34, or some other device capable of connecting the male portion 50 to the pedestal 28 or the mounting block 34.

The body 56 defines a plurality of openings 70 extending laterally through the body 56 in a transverse relationship relative to the longitudinal axis L. Preferably, the openings 70 are disposed within the collar portion 66 of the body 56 and are arranged radially about the longitudinal axis L. The plurality of openings 70 include a rim 72 adjacent the outer surface of the body 56 and extend around an outer periphery of the openings 70.

The locking mechanism 46 includes a plurality of locking balls 74 disposed within the male portion 50 of the fasteners 40, and a wedge pin 76 partially disposed within the lumen 62 of the body 56. One of the locking balls 74 is disposed within each of the openings 70. The rims 72 define a diameter slightly less than a diameter of the locking balls 74 to retain the locking balls 74 within the openings 70. Accordingly, a portion of the locking balls 74 having a diameter less than the diameter defined by the rim 72 of the openings 70 extend outward beyond the outer surface of the collar for engaging the female portion 52 of the fasteners 40 as will be described below. It should be appreciated that the locking balls 74 are moveable radially relative to the longitudinal axis L within the openings 70 in a direction transverse to the longitudinal axis L.

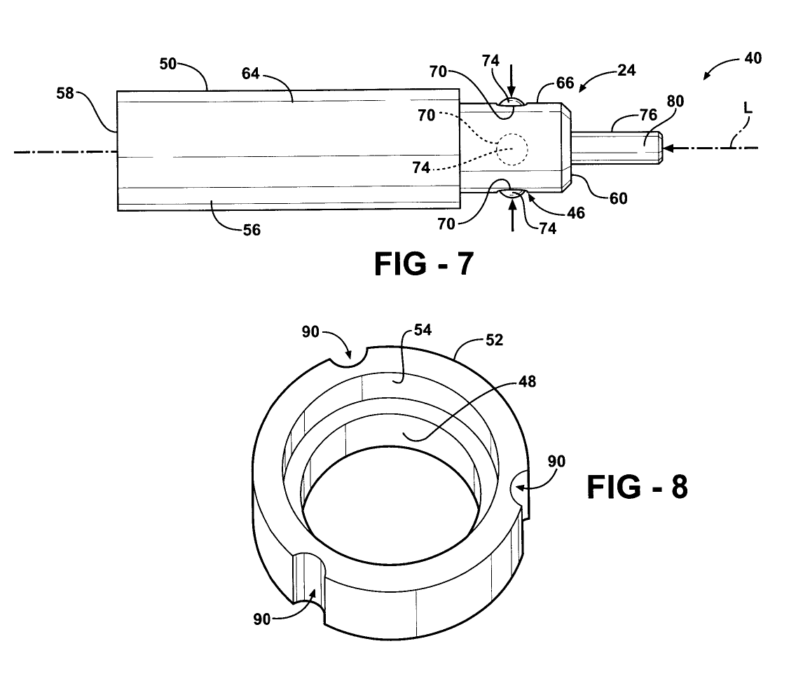

The wedge pin 76 is moveable within the lumen 62 along the longitudinal axis L between a lock position 22, shown in FIG. 6, and a release position 24, shown in FIG. 7. The lock position 22 biases the locking balls 74 radially outward against the body 56 to engage the annular groove 54 of the female portion 52 in interlocking engagement as described below. The release position 24 permits radial movement of the locking balls 74 radially inward toward the longitudinal axis L to disengage the locking balls 74 from interlocking engagement with the annular groove 54 of the female portion 52 as described below.

The wedge pin 76 is partially disposed within the lumen 62 and extends outwardly from the pedestal 28 and the body 56, through the second end 60 of the body 56 and through the bore 48 of the female portion 52, for engaging the actuator (not shown). The actuator is for moving the wedge pin 76 from the lock position 22 to the release position 24. The wedge pin 76 includes a first portion 78 having a first cross section, a second portion 80 having a second cross section, and a wedge portion 82 disposed between the first portion 78 and the second portion 80. The wedge portion 82 includes a wedge cross section continually decreasing in cross sectional area from the first cross section of the first portion 78 to the second cross section of the second portion 80 of the wedge pin 76. The first portion 78 of the wedge pin 76 includes a cross section substantially equal too, but slightly less than a cross section of the lumen 62. Accordingly, the first portion 78 of the wedge pin 76 is freely moveable within the lumen 62 along the longitudinal axis L. Preferably, the first cross section includes a circular cross section having a first diameter, and the second cross section includes a circular cross section having a second diameter smaller than the first diameter. The wedge cross section includes a circular cross section that continually decreases in size, i.e., tapers from the circular cross section of the first portion 78 towards the circular cross section of the second portion 80 of the wedge pin 76.

A spring 84 is disposed within the lumen 62, between the first end 58 of the body 56 and the wedge pin 76. The spring 84 biases the wedge pin 76 outward from the lumen 62 and into the lock position 22, as shown in FIGS. 4 through 6. The spring 84 also provides a resisting force against the movement of the wedge pin 76 along the longitudinal axis L. Preferably, the spring 84 includes a coil spring. In the locking position, the wedge pin 76 urges the locking balls 74 outward against the rims 72 of the openings 70, sandwiching the locking balls 74 between the wedge portion 82 of the wedge pin 76 and the rim 72. A portion of the locking balls 74 extends inward into the lumen 62, thereby preventing the large diameter section of the wedge pin 76 from passing. Accordingly, the spring 84 urges the wedge pin 76 along the longitudinal axis L, driving the locking balls 74 into their respective openings 70, with the locking balls 74 engaging the wedge section of the wedge pin 76 to retain the wedge pin 76 within the lumen 62.

The male portion 50 further includes an adjustment mechanism 86. The adjustment mechanism 86 is disposed within the lumen 62 at the first end 58 of the body 56. The adjustment mechanism 86 adjusts the resisting force of the spring 84. Preferably, the adjustment mechanism 86 includes a set screw 88 in threaded engagement with the body 56 within the lumen 62 at the first end 58 of the body 56. In other words, the set screw 88 is in threaded engagement with the shank portion 64 of the body 56, thereby closing the end of the lumen 62 opposite the collar portion 66. However, it should be appreciated that the adjustment mechanism 86 may include some other device not shown or described herein capable of adjusting the resisting force of the spring 84.

The resisting force of the spring 84 determines the amount of counter-pressure required to press the wedge pin 76 into the lumen 62, which in turn compresses the spring 84. The resisting force of the spring 84 may be adjusted by advancing or retracting the setscrew within the lumen 62. It should be understood that the spring 84 is compressed as the setscrew is advanced into the lumen 62, thereby increasing the resisting force of the force. Likewise, the further the setscrew is retracted from the lumen 62, thereby permitting the spring 84 to expand, the lower the resisting force of the spring 84 and the lower a release force required to press the wedge pin 76 into the release position 24.

As described above and with referring to FIGS. 3 through 5, the female portion 52 of the fastener assembly 40 includes the bore 48 extending along the longitudinal axis L and having a diameter slightly larger than a diameter of the outer surface of the collar. Accordingly, the collar is moveable through bore 48 of the female portion 52. The bore 48 defines the annular groove 54 for receiving the portion of the locking balls 74 extending outward from the outer surface of the collar when in the locking position. The annular groove 54 includes a semi-circular cross section transverse to the longitudinal axis L for engaging the portion of the locking balls 74 extending outward beyond the outer surface of the body 56 when in the lock position 22. The interaction between the annular groove 54 and the locking balls 74 prevent longitudinal movement of the female portion 52 relative to the male portion 50. In other words, the locking balls 74 are partially disposed within the annular groove 54 of the female portion 52 when in the lock position 22, thereby locking the female portion 52 relative to the male portion 50. The circular shape of the collar portion 66, the bore 48 and the annular groove 54, along with the interaction of the annular groove 54 and the locking balls 74, permit the female portion 52 to rotate relative to the male portion 50 about the longitudinal axis L while in the lock position 22. It should be understood that if the collar portion 66 and the bore 48 include a shape other than circular, the female portion 52 would not be rotatable about the male portion 50.

The female portion 52 includes an attachment mechanism 90 for attaching the female portion 52 to one of the mounting block 34 and the pedestal 28. As shown, the attachment mechanism 90 includes a plurality of semi-circular depressions in an outer periphery of the female portion 52 for engaging a plurality of pins to hole the female portion 52 within the mounting block 34. The attachment mechanism 90 may include threads for threaded engagement with the mounting block 34 or the pedestal 28, a snap ring or some other type of device capable of attaching the female portion 52 to the mounting block 34 or the pedestal 28.

To disconnect the fasteners 40, the wedge pin 76 is urged toward the setscrew into the release position 24, shown in FIG. 7. Accordingly, the second portion 80 of the wedge pin 76 moves toward the locking balls 74, thereby decreasing the diameter of the wedge section in engagement with the locking balls 74 to a point at which no portion of the locking balls 74 extends beyond the outer surface of the body 56. As such, the locking balls 74 are no longer in interlocking engagement with the groove of the female portion 52 and the female portion 52 is free to slide off the collar portion 66 of the body 56, thereby disconnecting the female portion 52 from the male portion 50. It should be appreciated that the female portion 52 must be removed while the spring 84 is compressed under the release force and the wedge pin 76 is in the release position 24 due to the spring 84 urging the wedge pin 76 back into the locking position upon discontinuance of the release force applied to the wedge pin 76.

The wedge pin 76 may be pressed inward to release the fasteners 40 by manually pushing the wedge pin 76. Alternatively, the actuator may be utilized to depress the wedge pin 76. The actuator may include a pneumatic device which delivers a pulse of air directed at the second portion 80 of the wedge pin 76, or may include a mechanical actuator, such as a robotic arm. It should be understood that the actuator may include other devices capable of providing the release force to the wedge pin 76 to urge the wedge pin 76 into the release position 24.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A work support apparatus for positioning a work piece, said work support apparatus comprising:
a pedestal;
a mounting block defining at least one bore extending through said mounting block, wherein the work piece is attachable to the mounting block;
a plurality of fasteners mounted to said pedestal and including a first group of fasteners for attaching said mounting block to said pedestal in a first orientation and a second group of fasteners for attaching said mounting block to said pedestal in a second orientation wherein the workpiece is orientated relative to said pedestal without detachment from said mounting block by attaching the mounting block to one of said first group of fasteners and said second group of fasteners;
each of said plurality of fasteners including a locking mechanism extending outwardly from said pedestal for engaging said mounting block in interlocking engagement and actuated through said bore of said mounting block.

2. A work support apparatus as set forth in claim 1 wherein said pedestal includes at least a first face having said first group of fasteners mounted on said first face and a second face having said second group of fasteners mounted on said second face.

3. A work support apparatus as set forth in claim 2 wherein said first group of fasteners include a plurality of first fastener subsets, said second group of fasteners includes a plurality of second fastener subsets, and said mounting block includes a plurality of mounting blocks such that several work pieces are selectively positionable on said pedestal in one of said first orientation and said second orientation simultaneously.

4. A work support apparatus as set forth in claim 1 wherein said bore defined by said mounting block includes a plurality of bores defined by said mounting block arranged in a pre-determined configuration to orient said mounting block in differing positions relative to said pedestal.

5. A work support apparatus as set forth in claim 1 wherein said mounting block defines an annular groove within said bore and wherein each of said plurality of fasteners includes a body defining a lumen extending through said body along a longitudinal axis and further defining a plurality of openings extending through said body transverse to said longitudinal axis and wherein said locking mechanism includes a plurality of locking balls with one of said plurality of locking balls disposed within each of said plurality of openings and a wedge pin moveable within said lumen along said longitudinal axis between a lock position biasing said plurality of locking balls radially outward against said body to engage said annular groove of said mounting block in interlocking engagement and a release position permitting radial movement of said plurality of locking balls radially inward toward said longitudinal axis to disengage said plurality of locking balls from said interlocking engagement with said annular groove of said mounting block,
said wedge pin extending outwardly form said pedestal and said body for selective engagement by an actuator through said bore of said mounting block to move said wedge pin from said lock position to said release position.

6. A work support apparatus as set forth in claim 5 wherein each of said plurality of fasteners includes a sp ring disposed with h in said lumen for biasing said wedge pin into said lock position and providing a resisting force against said movement of said wedge pin along said longitudinal axis.

7. A work support apparatus as set forth in claim 6 wherein each of said plurality of fasteners includes an adjustment mechanism disposed within said lumen for adjusting said resisting force of said spring.

8. A fastening assembly for interconnecting a mounting block to a pedestal and operable by an actuator, said assembly comprising:
a female portion for attachment to one of the mounting block and the pedestal and defining a bore and an annular groove within said bore; and
a male portion for attachment to another of the mounting block and the pedestal, said male portion including:
a body having a first end and a second end and defining a lumen extending between said first end and said second end along a longitudinal axis and further defining a plurality of openings extending through said body transverse to said longitudinal axis;
a plurality of locking balls with one of said plurality of locking balls disposed within each of said plurality of openings; and
a wedge pin moveable within said lumen along said longitudinal axis between a lock position biasing said plurality of locking balls radially outward against said body to engage said annular groove of said female portion in interlocking engagement and a release position permitting radial movement of said plurality of locking balls radially inward toward said longitudinal axis to disengage said plurality of locking balls from said interlocking engagement with said annular groove of said female portion;
said wedge pin partially disposed within said lumen and extending outwardly from said body through said second end of said body and through said bore of said female portion for selective engagement by the actuator to move said wedge pin from said lock position to said release position.

9. A fastening assembly as set forth in claim 8 wherein said male portion includes a spring disposed within said lumen between said first end of said body and said wedge pin for biasing said wedge pin into said lock position and providing a resisting force against said movement of said wedge pin along said longitudinal axis.

10. A fastening assembly as set forth in claim 9 wherein said spring includes a coil spring.

11. A fastening assembly as set forth in claim 9 wherein said male portion further includes an adjustment mechanism disposed within said lumen for adjusting said resisting force of said spring.

12. A fastening assembly as set forth in claim 11 wherein said adjustment mechanism includes a set screw in threaded engagement with said body within said lumen at said first end of said body.

13. A fastening assembly as set forth in claim 8 wherein said wedge pin includes a first portion having a first cross section, a second portion having a second cross section, and a wedge portion disposed between said first portion and said second portion and having a wedge cross section continually decreasing from said first cross section to said second cross section.

14. A fastening assembly as set forth in claim 13 wherein said lumen includes a circular cross section.

15. A fastening assembly as set forth in claim 14 wherein said first cross section includes a circular cross section having a first diameter and said second cross section includes a circular cross section having a second diameter smaller than said first diameter and said wedge cross section includes a circular cross section.

16. A fastening assembly as set forth in claim 8 wherein each of said plurality of locking balls define a diameter and wherein each of said plurality of openings include a rim disposed on an outer surface of said body and having a diameter less than said diameter of said locking balls.

17. A fastening assembly as set forth in claim 16 wherein said plurality of openings are arranged radially about said longitudinal axis.

18. A fastening assembly as set forth in claim 8 wherein said body includes a shank portion and a collar portion.

19. A fastening assembly as set forth in claim 18 wherein said shank portion includes a circular cross section having a shank diameter and said collar portion includes a circular cross section having a collar diameter smaller than said shank diameter.

20. A fastening assembly as set forth in claim 18 wherein said plurality of openings are disposed within said collar portion of said body.

21. A fastening assembly as set forth in claim 8 wherein said male portion includes a connecting mechanism for connecting said male portion to one of the mounting block and the pedestal.

22. A fastening assembly as set forth in claim 8 wherein said female portion includes an attachment mechanism for attaching said female portion to one of the mounting block and the pedestal.

23. A fastening assembly as set forth in claim 8 wherein said female portion includes a plurality of female portions attached to the mounting block and arranged in a pre-determined configuration.
